(19) United States
(12) Patent Application Publication
(10) Pub. No.: US 2026/0051562 A1
(43) Pub. Date: Feb. 19, 2026

(54) ELECTRICITY STORAGE UNIT

(71) Applicant: DAI NIPPON PRINTING CO., LTD., Tokyo (JP)

(72) Inventor: Jun FUKUDA, Tokyo (JP)

(73) Assignee: DAI NIPPON PRINTING CO., LTD., Tokyo (JP)

(21) Appl. No.: 19/103,616

(22) PCT Filed: Aug. 31, 2023
(86) PCT No.: PCT/JP2023/031662

§ 371 Date: Feb. 13, 2025

(30) Foreign Application Priority Data
Aug. 31, 2022 (JP) 2022-137900

(51) Int. Cl. H01M 10/6554; H01M 10/613; H01M 10/6556; H01M 50/103; H01M 50/209; H01M 50/548; H01M 50/557

(52) U.S. Cl. CPC H01M 10/6554; H01M 10/613; H01M 10/6556; H01M 50/103; H01M 50/209; H01M 50/548; H01M 50/557; H01M 2220/20

(57) ABSTRACT

An electricity storage unit includes a plurality of electricity storage devices arrayed along a first direction and a cooling member in the form of a plate disposed close to the plurality of arrayed electricity storage devices along a second direction intersecting with the first direction. The electricity storage devices each include a housing portion in a rectangular form for accommodating an electricity storage element and a flange portion protruding outward from the housing portion. The cooling member has a plurality of slits through which at least parts of portions of the flange portions of the electricity storage devices protruding along the second direction are disposed. The flange portions disposed through the slits are fixed to the cooling member.

### TECHNICAL FIELD

The present invention relates to an electricity storage unit.

### BACKGROUND ART

A conventional electricity storage device is disclosed in Patent Document 1. The electricity storage device has an electricity storage element enclosed in an outer package member. The electricity storage element has a cathode plate and an anode plate disposed opposite each other across a separator, with an electrolyte filling between the cathode and anode plates. To the cathode and anode plates respectively, electrode terminals are connected, which protrude out of the outer package member.

An assembled battery has a plurality of electricity storage devices as described above disposed side by side, with their cathode plates, and their anode plates, respectively connected together, and housed inside a cover. The electricity storage devices can be connected in series, with the cathode of one connected to the anode of the next.

### CITATION LIST

### Patent Literature

Patent Document 1: Japanese Patent registered as No. 3852110 B1

### SUMMARY OF INVENTION

### Technical Problem

In the conventional assembled battery described above, inside the cover, the gap between the cover and the electricity storage devices is filled with a filler. In the assembled battery, since the electricity storage device is covered with the filler, it is difficult to dissipate heat generated during charging and discharging, and this may lead to a rise in temperature. The heat generated through repetition of charging and discharging may make the electricity storage device, that is, the assembled battery, prone to deterioration.

An object of the present invention is to provide an electricity storage unit that suppresses a rise in temperature caused by heat generated during charging and discharging, and that is less prone to deterioration.

### Solution to Problem

An illustrative example of an electricity storage unit according to the present invention includes a plurality of electricity storage devices arrayed along a first direction and a cooling member in the form of a plate disposed close to the plurality of arrayed electricity storage devices along a second direction intersecting with the first direction. The electricity storage devices each include a housing portion that is in a rectangular form as seen from the first direction and that accommodates an electricity storage element and a flange portion that protrudes outward of the face of the housing portion intersecting with its face along the first direction. The cooling member has a plurality of slits through which at least parts of portions of the flange portions of the electricity storage devices protruding along the second direction are disposed. The flange portion disposed through the slits are fixed to the cooling member.

### Advantageous Effects of Invention

According to the present invention, it is possible to suppress a rise in temperature caused by heat generated during the charging and discharging of an electricity storage unit and thus to alleviate heat-induced deterioration.

### BRIEF DESCRIPTION OF DRAWINGS

FIG. 1 is a perspective view of an electricity storage unit.

FIG. 2 is a side sectional view of part of the electricity storage unit.

FIG. 3 is an exploded perspective view of the electricity storage unit.

FIG. 4 is a perspective view of an electricity storage device.

FIG. 5 is an exploded perspective view of the electricity storage device.

FIG. 6 is a sectional view of a laminated structure of a laminate sheet.

FIG. 7 is a side view of an electric vehicle.

FIG. 8 is a plan view of the electric vehicle.

FIG. 9 is an exploded perspective view of an electricity storage unit according to a first modified example.

FIG. 10 is an exploded perspective view of an electricity storage unit according to a second modified example.

FIG. 11 is an exploded perspective view of an electricity storage unit according to a third modified example.

FIG. 12 is an exploded perspective view of an electricity storage unit according to a fourth modified example.

FIG. 13 is an exploded perspective view of an electricity storage device in the electricity storage unit according to the fourth modified example.

FIG. 14 is a side sectional view of an electricity storage unit according to a fifth modified example.

FIG. 15 is a perspective view of an electricity storage unit according to a sixth modified example.

FIG. 16 is an exploded perspective view of an electricity storage unit according to a seventh modified example.

FIG. 17 is a side sectional view of electricity storage devices in the electricity storage unit according to the seventh modified example.

### DESCRIPTION OF EMBODIMENTS

Now, with reference to the accompanying drawings, an electricity storage unit according to one embodiment of the present invention will be described. Note that the embodiment described below is not meant to limit the scope of the present invention, which can thus be implemented with any modifications made within the spirit of the present invention.

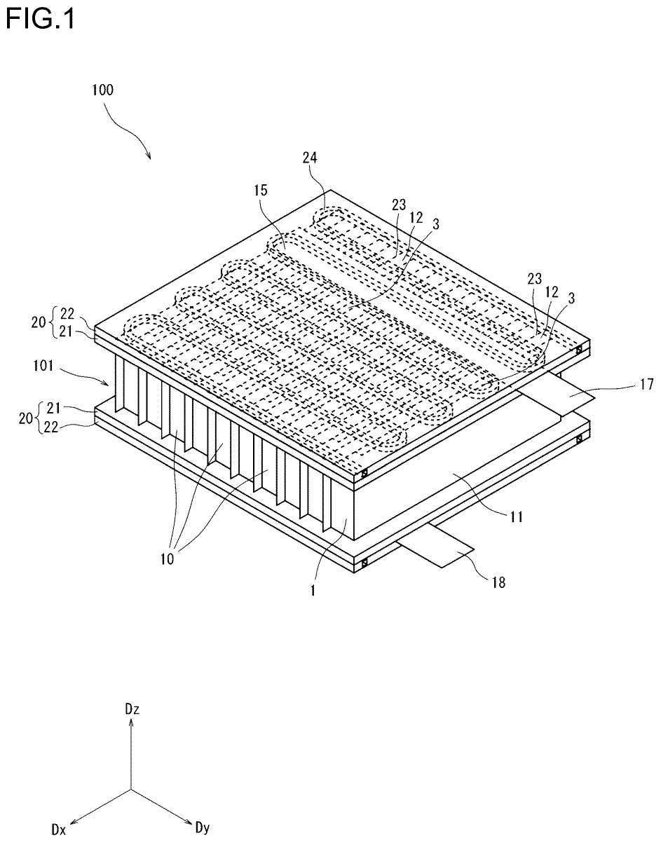

In the present description, an electricity storage unit 100 will be described with reference to a three-dimensional orthogonal coordinate system. As shown in FIG. 1, the electricity storage unit 100 has electricity storage devices 10 arrayed along direction Y. In other words, in the electricity storage unit 100, direction Y is a first direction, and is sometimes referred to as “first direction Dy.” In the electricity storage unit 100, direction Z is a second direction intersecting with the first direction Dy, and is sometimes referred to as “second direction Dz.” Direction X is sometimes referred to as “third direction Dx.” The top-bottom direction in FIG. 1 extends along the second direction Dz, which intersects with a longitudinal direction of electrode terminals 3 and 4 in the electricity storage device 10 (i.e., the third direction Dx) and with the first direction Dy.

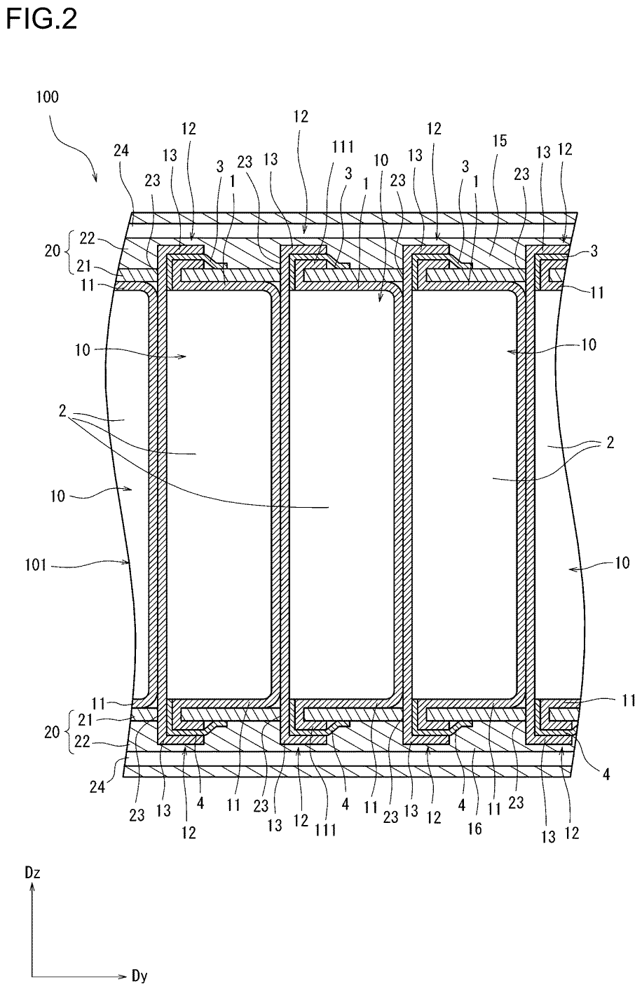

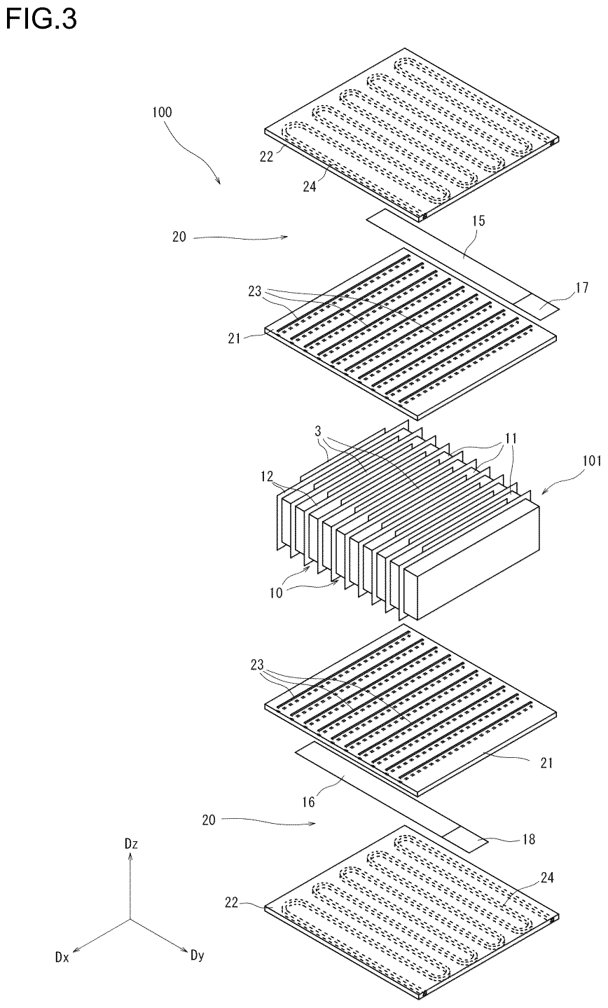

FIG. 1 is a perspective view of the electricity storage unit 100. FIG. 2 is a side sectional view of part of the electricity storage unit 100. FIG. 3 is an exploded perspective view of the electricity storage unit 100. The electricity storage unit 100 includes a plurality of electricity storage devices 10, a cooling member 20, a cathode bus bar 15, and an anode bus bar 16. In the electricity storage unit 100, the electricity storage devices 10 have an elongate form and are arrayed along direction Y (first direction Dy) intersecting with (here, orthogonal to) their longitudinal direction (third direction Dx). Note that a plurality of electricity storage devices 10 arrayed side by side is sometimes collectively referred to as an electricity storage device aggregate 101. While, in the electricity storage device aggregate 101 shown in FIGS. 1 and 3, ten electricity storage devices 10 are arrayed, the number of them arrayed in practice is not limited to ten and depends on the discharging capacity and the like required of the electricity storage unit 100.

### Electricity Storage Device 10

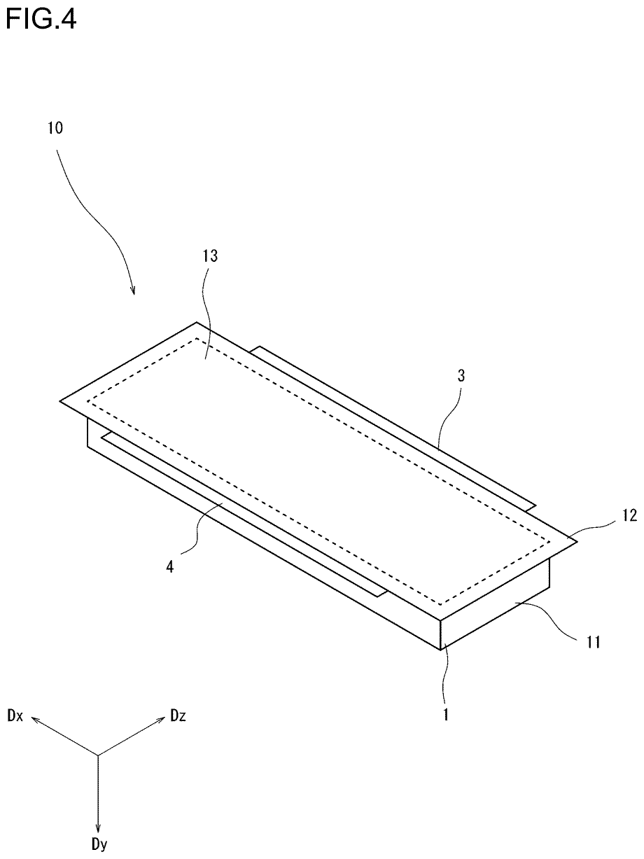

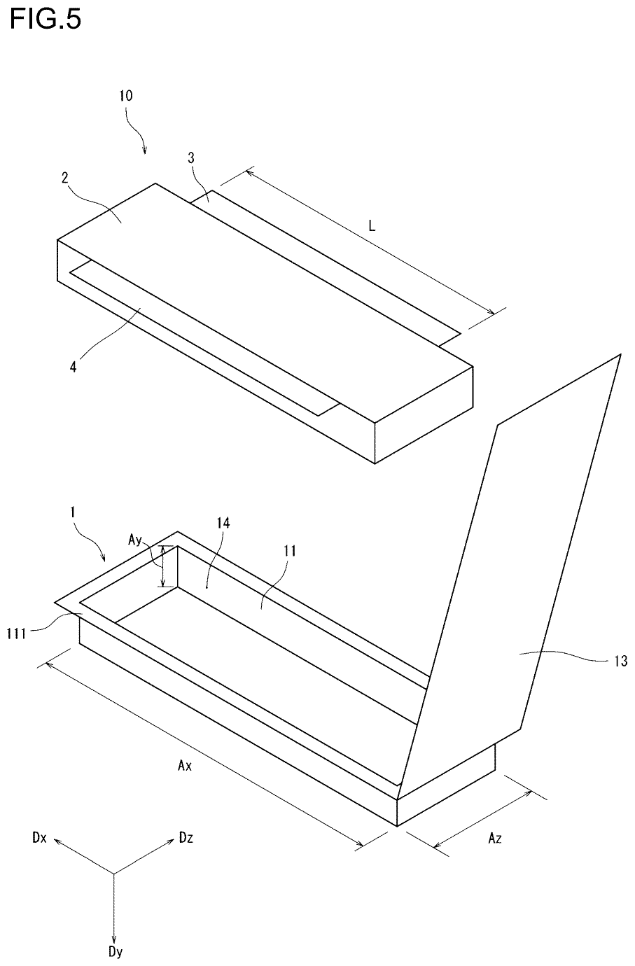

First, the electricity storage device 10 will be described with reference to the relevant drawings. FIG. 4 is a perspective view of the electricity storage device 10. FIG. 5 is an exploded perspective view of the electricity storage device 10.

As shown in FIGS. 4 and 5, the electricity storage device 10 includes an outer package member 1 and an electricity storage element 2. The electricity storage device 10 is a secondary battery with the electricity storage element 2 accommodated in the outer package member 1. Examples of the electricity storage device 10 include a lithium-ion battery, a lithium-polymer battery, an all-solid-state lithium-ion battery, a lead rechargeable battery, a nickel-hydride rechargeable battery, a nickel-cadmium rechargeable battery, a nickel-iron rechargeable battery, a nickel-zinc rechargeable battery, a silver oxide-zinc rechargeable battery, a metal-air battery, and a polyvalent cation battery.

### Outer Package Member 1

The outer package member 1 has a housing portion 11, a flange portion 12, and a lid portion 13. The housing portion 11 is a box-form member in the shape of a bottomed rectangular parallelepiped box that has an opening as an opening portion 14 (see FIG. 5) at one side along direction Y (first direction Dy). Inside the housing portion 11, the electricity storage element 2 is accommodated. The housing portion 11 has a peripheral sealing portion 111 extending outward from the peripheral of the opening portion 14. The peripheral sealing portion 111 has an outline substantially in a rectangular shape.

As shown in FIGS. 4 and 5, the lid portion 13 is formed unitarily with the peripheral sealing portion 111. Specifically, an end part of the peripheral sealing portion 111 along direction X (third direction Dx) and the lid portion 13 are unitarily connected. At the boundary between the peripheral sealing portion 111 and the lid portion 13, the lid portion 13 is bent so as to close the opening portion 14.

A peripheral part of the lid portion 13 is bonded to the peripheral sealing portion 111 of the housing portion 11. At least one of the face of the lid portion 13 facing the peripheral sealing portion 111 and the face of the peripheral sealing portion 111 facing the lid portion 13 has a thermal adhesive resin layer 43, which will be described later, laid on it. Thus, heating and pressing the peripheral part of the lid portion 13 and the peripheral sealing portion 111 of the housing portion 11 permits the peripheral part and the peripheral sealing portion 111 to be thermally bonded together. In this way, the lid portion 13 seals the opening portion 14.

The flange portion 12 is formed as a result of the peripheral part of the lid portion 13 and the peripheral sealing portion 111 being bonded together. In the flange portion 12, the electrode terminals 3 and 4, which will be described later, connected to the electricity storage element 2 are disposed. In the flange portion 12, the electrode terminals 3 and 4 are held between the peripheral sealing portion 111 and the peripheral part of the lid portion 13. Note that the electrode terminals 3 and 4 are in close contact with the peripheral sealing portion 111 and the lid portion 13. Here, “close contact” means that they are in such contact with each other that the electrolyte sealed in the housing portion 11, or the gas generated by the charging and discharging does not leak out.

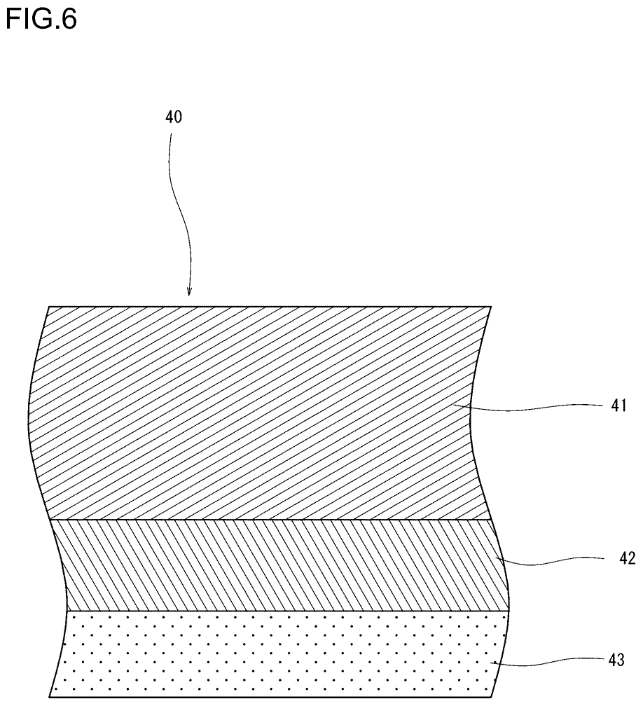

The outer package member 1 is formed of a laminate sheet 40 having at least one electrically insulating layer. The laminate sheet 40 forming the outer package member 1 will now be described with reference to the relevant drawing. FIG. 6 is a sectional view of the laminated structure of the laminate sheet 40. As shown in FIG. 6, the laminate sheet 40 is formed by laying a base layer 41, a barrier layer 42, and a thermal adhesive resin layer 43 on each other in this order. The laminate sheet 40 preferably has a thickness of 50 μm or more with consideration given to the strength of the outer package member 1 but 400 μm or less with consideration given to weight reduction in the electricity storage device 10. The thicker the barrier layer 42, the higher the strength and the thermal conductivity. Thus, in a case where priority is given to the strength and thermal conductivity of the outer package member 1 at the cost of an increase in the weight of the electricity storage device 10, the laminate sheet 40 can be given a thickness of between 1 mm and 2 mm or more.

The base layer 41 is electrically insulating, and is formed of a resin film such as of nylon, polyester, or polyethylene terephthalate. The base layer 41 are formed with a thickness of, for example, 10 μm or more but 75 μm or less. For enhanced heat resistance, the base layer 41 is preferably formed of a uniaxially stretched film or a biaxially stretched film. The thicker the base layer 41, the poorer the thermal conductivity along the thickness direction. For example, if sufficient thermal conductivity can be obtained in the barrier layer 42, the base layer 41 can be given a thickness of about 500 μm.

For enhanced pinhole resistance and electrical insulation, the base layer 41 can be formed by laying a plurality of resin films of different materials. In that case, the plurality of resin films are bonded together with a polyurethane-based, acrylic, or another adhesive. In the embodiment, the laminate sheet 40 is formed by laying together polyethylene terephthalate (with a thickness of 12 μm) and nylon (with a thickness of 15 μm) with adhesive (with a thickness 4 μm).

The barrier layer 42 prevents entry of moisture, oxygen, light, and the like. Usable as the barrier layer 42 is, for example, a foil of metal such as aluminum, aluminum alloy, stainless steel, titanium, iron, or high-strength steel. The barrier layer 42 is formed with a thickness of, for example, 10 μm or more but 500 μm or less. The base layer 41 and the barrier layer 42 are bonded together with polyurethane-based, acrylic, or another adhesive (not shown). In the laminate sheet 40 according to the embodiment, the barrier layer 42 is formed of an aluminum foil with a thickness of 40 μm.

The thermal adhesive resin layer 43 can be of any resin that exhibits thermal adhesion, and is formed of a thermal adhesive resin such as polypropylene, acid-modified polypropylene, low-density polyethylene, or linear low-density polyethylene. The thermal adhesive resin layer 43 can be formed by laying on each other a plurality of resins of different materials. The thermal adhesive resin layer 43 can be formed with a thickness of, for example, 10 μm or more but 100 μm or less. The thermal adhesive resin layer 43 is formed by extrusion onto the barrier layer 42. A film that forms the thermal adhesive resin layer 43 can be bonded to the barrier layer 42 with adhesive in between. Depending on the size of the electricity storage element 2 and the weights of the electricity storage element 2 and the electrolyte that are to be accommodated in the housing portion 11, the thermal adhesive resin layer 43 can be given a thickness of 100 μm or more but 500 μm or less.

In the laminate sheet 40 according to the embodiment, the thermal adhesive resin layer 43 is formed by extruding acid-modified polypropylene (with a thickness of 40 μm) and polypropylene (with a thickness of 40 μm) in this order onto the barrier layer 42.

### Electricity Storage Element 2

In the electricity storage device 10, the housing portion 11 accommodates the electricity storage element 2 along with the electrolyte. The electricity storage element 2 has a cathode plate, an anode plate, and a separator (none of them shown). The electricity storage element 2 is formed by arranging the cathode plate and the anode plate opposite each other across the separator, which is an insulator. For example, a separator, a cathode plate, and an anode plate, all in an elongate form, are laid on each other and are wound up to form the electricity storage element 2. The electricity storage element 2 can instead be formed by laying on each other a cathode plate, a separator, an anode plate, and a separator, all in a sheet form, in this order in a plurality of tiers. Or, the electricity storage element 2 can be formed by folding and laying on each other a separator, a cathode plate, and an anode plate, all in an elongate form. The electricity storage element 2 is disposed in the electrolyte.

In the embodiment, as the electrolyte, a liquid electrolyte, that is, an electrolyte solution is used to fill inside the outer package member 1. As the electrolyte, a solid or gel electrolyte can instead be used.

To the cathode and anode plates, the electrode terminals 3 and 4 are connected respectively. The electrode terminals 3 and 4 are electrically conductive and are disposed so as to protrude out of the housing portion 11. In the electricity storage device 10, the electrode terminals 3 and 4 are input/output terminals for charging and discharging the electricity storage element 2.

The electrode terminals 3 and 4 protrude out from the opposite longer sides, respectively, of the opening portion 14. The electrode terminals 3 and 4 are held between the peripheral sealing portion 111 and the lid portion 13. The peripheral sealing portion 111 and the lid portion 13 are heat sealed with the electrode terminals 3 and 4 held in between. While not shown in the embodiment, the electrode terminals 3 and 4 are held between the peripheral sealing portion 111 and the lid portion 13 via a thermally adhesive tab film (not shown). This helps enhance airtightness around the electrode terminals 3 and 4.

In the electricity storage device 10, the electrode terminals 3 and 4 protrude out from its opposite end faces along direction Z (second direction Dz). Specifically, the electrode terminals 3 and 4 are exposed out via the flange portion 12. In the electricity storage unit 100 according to the embodiment, the electrode terminal 3 is disposed in a top part of the electricity storage device 10, and the electrode terminal 4 is disposed in a bottom part of the electricity storage device 10. The positions of the electrode terminals 3 and 4 can be reversed.

The electrode terminals 3 and 4 protrude along the lateral direction of the electricity storage device 10. In the electricity storage element 2, the dimension between the electrode terminals 3 and 4 is shorter than if they protrude along the longitudinal direction. Thus, in the electricity storage device 10, the internal resistance during charging and discharging can be reduced. It is thus possible to provide an electricity storage device 10 that can give high-output discharging and rapid charging.

The electrode terminals 3 and 4 protrude from the longer sides of the opening portion 14. Thus, the electrode terminals 3 and 4 can be given a large width L along their longitudinal directions (along the third direction Dx) according to the length Ax of the opening portion 14 along its longitudinal direction (third direction Dx).

It is thus possible to keep the electrical resistances of the electrode terminals 3 and 4 low, and suppress heat generation in the electrode terminals 3 and 4 during charging and discharging. This helps alleviate heat-induced deterioration of the electrode terminals 3 and 4 as well as of the electricity storage element 2. In addition, reduced heat generation permits application of a high voltage to the electrode terminals 3 and 4 during charging, achieving faster charging. In this way, it is possible to provide an electricity storage device 10 less prone to deteriorate after repeated charging and discharging with a high voltage.

For example, the electrode terminals 3 and 4 can be given a width L along direction X of more than a half of the length Ax of the opening portion 14 along its longitudinal direction. This helps give the electrode terminals 3 and 4 an increased width relative to the discharge capacity of the electricity storage device 10. It is thus possible to further reduce the resistance of the electrode terminals 3 and 4. For example, in a case where the length Ax of the opening portion 14 along its longitudinal direction is 105 cm, if the widths L of the electrode terminals 3 and 4 exceed 100 cm, poorer airtightness around the electrode terminals 3 and 4 may result. Accordingly, the electrode terminals 3 and 4 are formed with a width L of 5 cm or more but 100 cm or less. The width L is preferably 10 cm or more but 100 cm or less, and more preferably 15 cm or more but 100 cm or less. Note that, for an electricity storage element 2 approximately so sized that the opening portion 14 of the housing portion 11 has, along its longitudinal direction, a length Ax of 300 cm and, along its lateral direction, a length Az of 10 cm, the electrode terminals 3 and 4 can be given a width L along direction X of around 280 cm.

The electrical resistance of the electrode terminals 3 and 4 is proportional to their length along the direction of flow of the electric current, that is, the direction orthogonal to the width L. If the electrode terminals 3 and 4 protrude from the outer edge of the flange portion 12 by more than 50 mm, high electrical resistance and high heat generation result. On the other hand, if they protrude from the outer edge of the flange portion 12 by less than 0.5 mm, it is not easy to connect the electrode terminals 3 and 4 to the cathode and anode bus bars 15 and 16. Accordingly, the protrusion length of the electrode terminals 3 and 4 from the outer edge of the flange portion 12 is preferably 0.5 mm or more but 50 mm or less.

The housing portion 11 is formed by cold forming of a laminate constituting the outer package member 1 described above. The depth Ay of the housing portion 11 is determined according to the thickness of the barrier layer 42 of the laminate with attention given not to develop cracks or wrinkles during forming. In the embodiment, for the barrier layer 42 with a thickness of 40 μm, the housing portion 11 is formed with a depth of 5 mm to 10 mm. In this case, the housing portion 11 is formed with a radius of, for example, about 3 mm in each corner of the faces perpendicular to its depth direction, and with a radius of, for example, about 1.5 mm in each corner of the faces parallel to the depth direction. Note that, increasing the thickness of the barrier layer 42 makes it possible to give the housing portion 11 a depth of, for example, 5 mm to 30 mm.

Moreover, if the opening portion 14 has a ratio of longer side to shorter side (side ratio =the length Ax along the longitudinal direction/the length Az along the lateral direction) that is less than 1.5, the electricity storage device 10 has low discharge capacity. Thus, giving the opening portion 14 a side ratio of 1.5 or more helps increase the discharge capacity of the electricity storage device 10. However, if the side ratio of the opening portion 14 exceeds 30, it is difficult to form the outer package member 1, resulting in a low yield. Thus, giving the opening portion 14 a side ratio of 30 or less helps improve the yield in the formation of the outer package member 1. That is, the side ratio for the opening portion 14 is preferably 1.5 or more but 30 or less.

### Electricity Storage Device Aggregate 101

As shown in FIGS. 1 to 3, the electricity storage device aggregate 101 has ten electricity storage devices 10 arrayed along the first direction Dy. The electricity storage devices 10 are arrayed such that the depth direction of the housing portion 11 is aligned with the first direction Dy. In this case, the opening portions 14 of the electricity storage devices 10 are arrayed so as to point in the same direction.

### Cooling Member 20

In the electricity storage unit 100, the cooling member 20 is a member in the form of a rectangular plate and is disposed adjacent to the plurality of electricity storage devices 10 along direction Z (second direction Dz). Specifically, they are disposed at the top and bottom sides of the electricity storage device aggregate 101 so as to cover the top and bottom surfaces of the electricity storage device aggregate 101. The cooling member 20 releases the heat generated in the electricity storage device 10 to the outside, and suppresses a rise in temperature generated inside the electricity storage device 10, that is, it cools the electricity storage device 10.

The cooling member 20 includes a first cooling plate 21 and a second cooling plate 22. As shown in FIGS. 1 to 3 and so on, the first cooling plate 21 is disposed in contact with the electricity storage device aggregate 101. Thus, heat is transmitted from the electricity storage device aggregate 101 to the first cooling plate 21. The heat is then transmitted from the first cooling plate 21 to the second cooling plate 22. To achieve that, the first cooling plate 21 is formed of a material with a high thermal conductivity such as metal (aluminum, copper, or the like) or graphite. In addition, the second cooling plate 22 is configured to have a refrigerant passage 24 formed inside it, and thus, it is formed of a material, such as metal (aluminum, copper, and the like), that has a high thermal conductivity and with which the refrigerant passage 24 is easily formed.

As shown in FIGS. 2 and 3, the first cooling plate 21 has a plurality of slits 23 that penetrate it along the width direction. The slit 23 has substantially the shape of a rectangular, of which the longitudinal direction is aligned with direction X (third direction Dx) when seen from direction Z (second direction Dz). The plurality of slits 23 are provided in the same number as the electricity storage devices 10 and are arrayed along direction Y (first direction Dy).

In the electricity storage unit 100, the flange portion 12 and the electrode terminal 3 that protrude at the top side of the electricity storage device aggregate 101 are disposed through the slit 23 in the cooling member 20 disposed at the top side. Thus, the first cooling plate 21 is disposed in contact with the outer surfaces of the housing portions 11 of the electricity storage devices 10. In other words, the housing portion 11 of the electricity storage device 10 has a peripheral wall portion formed along direction Y (first direction Dy) and the first cooling plate 21 is disposed in contact with the outer surface of the peripheral wall portion of the housing portion 11. Here, the peripheral sealing portion 111 and the lid portion 13 of the flange portion 12 at the top side can be fixed to the inner surface of the slit 23. The fixing of the peripheral sealing portion 111 and the lid portion 13 can be achieved, for example, by bonding with thermally conductive adhesive.

Parts of the flange portion 12 at the top side and the electrode terminal 3 that protrude above through the slit 23 are bent into contact with and fixed to the first cooling plate 21. Specifically, the bent part of the peripheral sealing portion 111 of the flange portion 12 at the top side and the bent part of the electrode terminal 3 are fixed to the first cooling plate 21. Note that in the electricity storage unit 100 according to the embodiment, while the flange portion 12 at the top side protruding through the slit 23 is bent toward the peripheral sealing potion 111, it can instead be bent toward the lid portion 13. In that case, the lid portion 13 that is disposed through the slit 23 is fixed to the first cooling plate 21.

The fixing of the flange portion 12 at the top side and the electrode terminal 3 to the first cooling plate 21 is achieved, for example, by bonding with thermally conductive adhesive. By doing so, it is possible to enhance the efficiency of heat conduction from the flange portion 12 at the top side and the electrode terminal 3 to the first cooling plate 21. Note that the fixing of the flange portion 12 at the top side and the electrode terminal 3 to the first cooling plate 21 at the top side can be achieved, instead of with the thermally conductive adhesive, by resistance welding, laser welding, ultrasonic welding, and fastening with screws.

The flange portion 12 and the electrode terminal 4 that protrude at the bottom side of the electricity storage device aggregate 101 are disposed through the slit 23 in the first cooling plate 21 disposed at the bottom side. Thus, the first cooling plate 21 is disposed in contact with the outer surfaces of the housing portions 11 of the electricity storage devices 10. Then, parts of the flange portion 12 at the bottom side and the electrode terminal 4 that protrude below through the slit 23 are bent to be fixed in contact with the first cooling plate 21. The fixing of the flange portion 12 at the bottom side and the electrode terminal 4 to the first cooling plate 21 at the bottom side can be achieved, for example, by bonding with thermally conductive adhesive. By doing so, it is possible to enhance the efficiency of heat conduction from the flange portion 12 at the bottom side and the electrode terminal 4 to the first cooling plate 21. Note that the fixing of the flange portion 12 at the bottom side and the electrode terminal 4 to the first cooling plate 21 at the bottom side can be achieved, instead of with the thermally conductive adhesive, by resistance welding, laser welding, ultrasonic welding, or fastening with screws.

Also between the first cooling plate 21 and the housing portion 11, a material with high thermal conductivity, such as thermally conductive grease, can be laid. In addition, they can be bonded and fixed together with thermally conductive adhesive. This helps avoid leaving a gap (layer of air) between the first cooling plate 21 and the housing portion 11, enhancing the efficiency of heat conduction. Note that the fixing together of the first cooling plate 21 to the housing portion 11 can be achieved, instead of with thermally conductive adhesive, by resistance welding, laser welding, ultrasonic welding, or fastening with screws.

To prevent electrical leakage, electrical discharge, or the like from the electrode terminals 3 and 4 to the first cooling plates 21, the surface of the first cooling plate 21 is subjected to electrical insulation treatment. Note that electrical insulation treatment can be applied only to the part of the first cooling plate 21 with which the electrode terminals 3 and 4 may make contact.

The second cooling plate 22 is fixed in contact with the surface of the first cooling plate 21 opposite its surface contacting the electricity storage device aggregate 101. Between the first and second cooling plates 21 and 22, a material with high thermal conductivity, such as thermally conductive grease, can be laid. In addition, they can be bonded and fixed together with thermally conductive adhesive. This helps avoid leaving a gap (layer of air) between the first and second cooling plates 21 and 22, enhancing the efficiency of thermal conductivity from the first cooling plate 21 to the second cooling plate 22. Note that the fixing together of the first cooling plate 21 to the second cooling plate 22 can be achieved, instead of with thermally conductive adhesive, by resistance welding, laser welding, ultrasonic welding, or fastening with screws.

Here, the flange portion 12 and the electrode terminal 3 are held between the first and second cooling plates 21 and 22. Also, the flange portion 12 and the electrode terminal 4 are held between the first and second cooling plates 21 and 22. Between the flange portion 12 and the electrode terminal 3 together and the second cooling plate 22, or between the flange portion 12 and the electrode terminal 4 together and the second cooling plate 22, a material with high thermal conductivity, such as thermally conductive grease can be provided. In addition, they can be bonded and fixed together with thermally conductive adhesive. Note that the fixing together of the flange portion 12 and the electrode terminals 3 and 4 to the second cooling plates 22 can be achieved, instead of with thermally conductive adhesive, by resistance welding, laser welding, ultrasonic welding, and fastening with screws.

To prevent electrical leakage, electrical discharge, or the like from the electrode terminals 3 and 4 to the second cooling plates 22, the surface of the second cooling plate 22 is subjected to electrical insulation treatment. Note that electrical insulation treatment can be applied only to the part of the second cooling plate 22 with which the electrode terminals 3 and 4 may make contact.

As shown in FIGS. 1 to 3, the second cooling plate 22 has inside it a refrigerant passage 24 through which refrigerant circulates. The refrigerant passage 24 comprises passages extending along direction Y (first direction Dy) and arrayed side by side along direction X (third direction Dx). These passages are connected from one to the next in their end parts along direction Y (first direction Dy). In other words, the refrigerant passage 24 is formed as a meandering single passage. In this way, the refrigerant passage 24 is disposed over the entire region of the second cooling plate 22. Opposite end parts of the refrigerant passage 24 are open at side surfaces of the second cooling plate 22. The refrigerant flows in through one of those openings and flows out through the other.

While, as shown in FIG. 3, the refrigerant passage 24 is configured with a straight passage extending along the first direction Dy (direction Y) formed into a meandering shape, this is not meant as any limitation. For example, it can instead be configured with a straight passage extending along the third direction Dx (direction X) formed into a meandering shape. The longer the refrigerant passage 24, the larger the area of contact between the refrigerant and the second cooling plate 22, leading to higher cooling efficiency.

Piping (not shown) is connected to the refrigerant passage 24 to make the refrigerant circulate. To the piping, are connected, in addition to the refrigerant passage 24, a refrigerant pump and a heat exchanger (neither is shown). The refrigerant is circulated through the duct by the refrigerant pump. In the refrigerant passage 24, the refrigerant absorbs heat from the second cooling plate 22 and is itself heated, cooling the second cooling plate 22. Thus, via the first cooling plate 21 contacting the second cooling plate 22, the electricity storage unit 100 is cooled.

After being heated, the refrigerant releases the heat to the outside in the heat exchanger and is thereby cooled again, then flowing into the refrigerant passage 24. In this way, circulating the refrigerant permits efficient cooling of the electricity storage unit 100. This suppresses a rise in the temperature of the electricity storage unit 100 and alleviates heat-induced deterioration of the electricity storage unit 100. The refrigerant flowing through the refrigerant passage 24 can be liquid (coolant fluid, cooling water, oil, or the like) or gas (nitrogen gas, helium gas, or the like). The refrigerant preferably has a temperature of 20° C. or more but 40° C. or less.

The refrigerant varies according to the place where the electricity storage unit 100 is installed and the purpose of its installation. For example, if the electricity storage unit 100 is used as a power source for driving an electric vehicle 200, cooling water can be used as the refrigerant.

Note that, while the modified example deals with a configuration where the refrigerant passage 24 is formed as a single passage from an inlet to an outlet, this is not meant as any limitation. The refrigerant passage 24 can have what is called a parallel-flow piping structure in which refrigerant flows in at one end of the second cooling plate 22, then branches into a plurality of passages to pass through the second cooling plate 22, and then joins to flow out.

Using of the electricity storage unit 100 at a place where the ambient temperature is low, such as in a cold region, may lead to poor performance of the electricity storage unit 100 because of low temperature. In this case, heated refrigerant can be circulated so as to heat the electricity storage unit 100 to a temperature adequate for its operation. Or a configuration is also possible where, on the occasion of a cold start, heated refrigerant is first circulated and then, after the operation stabilizes, cooled refrigerant is circulated.

For example, the second cooling plate 22 can be produced by bonding together plates that each have grooves in the same shape as the refrigerant passage 24 formed in its one side. This is not meant to limit the production method for the second cooling plate 22: it can be formed by placing a single meandering pipe in a mold and injection-molding into it a material constituting the second cooling plate 22. The second cooling plate 22 can be molded by any other method.

### Cathode Bus Bar 15 and Anode Bus Bar 16

In the electricity storage unit 100, a cathode bus bar 15 and an anode bus bar 16 are formed of an electrically conductive material. The cathode bus bar 15 is disposed between the first and second cooling plates 21 and 22 in the cooling member 20 at the top side. Note that, in the electricity storage unit 100 according to the embodiment, the cathode bus bar 15 is fixed to both of the first and second cooling plates 21 and 22 in the cooling member 20 at the top side. To the cathode bus bar 15, the electrode terminals 3 of the electricity storage devices 10 are electrically connected. In other words, the cathode bus bar 15 electrically connects together the electrode terminals 3 of the electricity storage devices 10.

In the electricity storage unit 100 according to the embodiment, the anode bus bar 16 is disposed between the first and second cooling plates 21 and 22 in the cooling member 20 at the bottom side. To the anode bus bar 16, the electrode terminals 4 of the electricity storage devices 10 are electrically connected. Thus, the electrode terminals 4 of the electricity storage devices 10 are electrically connected together.

In the electricity storage unit 100, the plurality of electricity storage devices 10 are electrically connected in parallel by providing the cathode and anode bus bars 15 and 16. Note that, in the electricity storage unit 100, the electricity storage devices 10 can be connected, instead of in parallel, in series. Or a given number of electricity storage devices 10 can be connected in series to constitute an electricity storage device stack and then a plurality of such electricity storage device stacks can be connected in parallel. The method for connecting electricity storage devices 10 is decided based on the output voltage and the output current required of the electricity storage unit 100.

To the cathode and anode bus bars 15 and 16, lead-out terminals 17 and 18 are connected respectively. The lead-out terminals 17 and 18 are led out of a case, which is not shown, that covers an outer part of the electricity storage unit 100, and serve as external connection terminals to be connected to an external device such as a charging device or a load (neither is shown). In other words, via the lead-out terminals 17 and 18, the electricity storage unit 100 is discharged and charged. Note that the external terminal 17 is the cathode and the external terminal 18 is the anode.

The electricity storage unit 100 is configured as described above.

### Heat Dissipation of Electricity Storage Unit 100

In the electricity storage unit 100, during charging and discharging, heat is generated in the electrode terminals 3 and 4 and the electricity storage element 2. The heat generated in the electricity storage element 2 transmits to the housing portion 11. In the electricity storage device 10, since the flange portion 12 and the electrode terminals 3 and 4 are disposed through the slit 23 in the first cooling plate 21 in the cooling member 20, no member such as the flange portion 12 or the electrode terminals 3 or 4 is held between the first cooling plate 21 and the housing portion 11. In other words, the first cooling plate 21 is in direct contact with the housing portion 11. Thus, the heat in the housing portion 11 easily transmits to the first cooling plate 21. In addition, the heat in the electrode terminals 3 and 4 transmits to the first cooling plate 21.

The heat transmitted from the electrode terminals 3 and 4 and the electricity storage element 2 to the first cooling plate 21 is transmitted to the second cooling plate 22. In the second cooling plate 22, a cold refrigerant is circulated through the refrigerant passage 24 formed inside it. Thus, the heat transmitted to the second cooling plate 22 is absorbed by the refrigerant and is released to the outside together with the refrigerant. Note that the second cooling plate 22 has a size enough to cover the top or bottom surfaces of the electricity storage unit 100. In other words, the second cooling plate 22 is in contact with the outside air over a large area, and thus the heat transmitted to the second cooling plate 22 is not only absorbed by the refrigerant but also released directly to the outside air simultaneously with the absorption in the refrigerant.

In this way, the heat generated in the electrode terminals 3 and 4 and the electricity storage element 2 less tends to be trapped in the electricity storage unit 100 ant this helps suppress a rise in temperature in the electricity storage unit 100, especially in the electricity storage element 2.

Thus, it is possible to alleviate heat-induced deterioration of the electricity storage unit 100. It is also possible to effectively release the heat resulting from passing of high current, and this helps suppress a rise in temperature during charging in which a high current is suppled (a high voltage is applied). Accordingly, even a rapid charging in which a high current is supplied (a high voltage is applied) less tends to cause a rise in temperature or deterioration.

The heat in the housing portion 11 also transmits via the flange portion 12 to the cooling member 20. To the electricity storage element 2, the electrode terminals 3 and 4 are connected, and thus the heat transmitted to the electrode terminals 3 and 4 transmits, together with the heat generated in the electrode terminals 3 and 4, to the cooling member 20. This too helps suppress a rise in temperature in the electricity storage device 10.

In the electricity storage unit 100 according to the embodiment, the electrode terminals 3 and 4 are connected to the cathode and anode bus bars 15 and 16 respectively. This is not meant as any limitation to such a configuration, and at least one of the first and second cooling plates 21 and 22 in the cooling member 20 disposed at opposite sides of the electricity storage device aggregate 101 along direction Z (second direction Dz) can serve as a bus bar as well. For example, the electrode terminal 3 can be electrically connected to the first cooling plate 21, and electrical insulation treatment can be applied to where the electrode terminal 3 and the second cooling plate 22 make contact. With this configuration, it is possible to use the first cooling plate 21 as the cathode bus bar while preventing electrical leakage, electrical discharge, or the like to the second cooling plate 22. The same applies to the electrode terminal 4; the first cooling plate 21 can be used as the anode bus bar 16. In this way, it is possible to omit the cathode and anode bus bars 15 and 16 and simplify the structure of the electricity storage unit 100.

The electricity storage unit 100 can be packed in a package case (not shown) to be provided as a package. In this case, the outer package case can be formed of a laminate with a thermal adhesive resin layer, a metal foil, and a base layer laid on each other. In addition, the gap between the electricity storage unit 100 and the outer package case can be filled with a filler (not shown) and the thermal adhesive resin layer can be thermally bonded to seal the outer package case. The outer package case can instead be formed as an injection-molded article.

At least one of the top and bottom surfaces of the housing portion 11 of the electricity storage device 10 can have an opening (not shown). This opening is provided to collect the electrolyte that has leaked from the electricity storage device 10 and the gas (e.g., hydrogen gas) resulting from repeated charging and discharging of the electricity storage device 10. For example, through an opening provided at the bottom, the electrolyte can be collected. On the other hand, through an opening provided at the top, the gas can be collected. The opening, for example, can have an openable/closable structure with a plug. The opening can be fitted with a breaker valve, a check valve, or the like. The opening can be fitted also with a safety valve that opens when the pressure inside the housing portion 11 of the electricity storage device 10 is equal to or more than a predetermined value and that closes when it is less than the predetermined value. A member with any other structure can be disposed at the opening.

The opening can be configured such that it is closed when the electricity storage device 10 is in stable operation and can be opened and closed as necessary, or can be configured to be open on occurrence of a fault such as a rise in the internal pressure. In a case where the electricity storage unit 100 is used with the package case accommodating it, the package case can also be provided with an opening.

### Arrangement of Electricity Storage Unit 100 in Electric Vehicle 200

As mentioned above, the electricity storage unit 100 with a plurality of electricity storage devices 10 arrayed in it can be charged and discharged with a high voltage and hence in a short time; it can thus be suitably used as a power source in a BEV (battery electric vehicle) and a PEHV (plug-in hybrid electric vehicle) as well as in an HEV (hybrid electric vehicle) and a 48V micro hybrid vehicle.

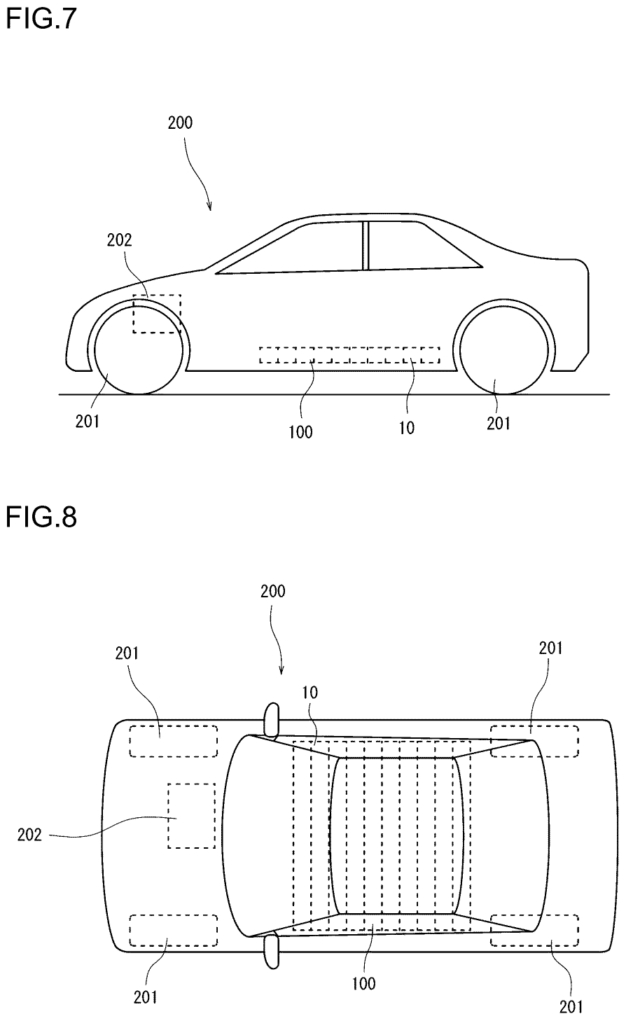

FIG. 7 is a side view of an electric vehicle 200. FIG. 8 is a plan view of the electric vehicle 200. As shown in FIG. 7, the electric vehicle (moving object) 200 includes a driving motor 202 as a power source for driving wheels 201. In a bottom part of the body (moving object body) (i.e., under the floor) of the electric vehicle 200, the electricity storage unit 100 is provided as a driving source for supplying electric power to the drive motor 202.

As shown in FIG. 8, the electricity storage unit 100 is arranged such that the first direction Dy (direction Y) is aligned with a front-rear direction of the electric vehicle 200. In addition, the electricity storage unit 100 is arranged such that the third direction Dx (direction X) is aligned with the left-right direction of the electric vehicle 200 and that the second direction (direction Z) is aligned with the height direction of the electric vehicle 200 (i.e., gravity direction).

In the electricity storage unit 100, the electricity storage devices 10 are arranged such that their second direction Dz (direction Z) is aligned with the height direction. In this case, the arrayed electricity storage devices 10 extend longitudinally along the third direction Dx (direction X). Since the arrayed electricity storage devices 10 have a length Ax along direction X (front-rear direction) longer than a length Az along Z direction (height direction), it is possible to keep the height of the electricity storage unit 100 low without reducing its discharge capacity. In this way, it is possible to keep the height of the electricity storage unit 100 low and to improve the comfortableness in the electric vehicle 200.

In a case where the electric vehicle 200 is a sedan or compact car with a low overall height, the electricity storage unit 100 preferably has a height of, for example, 100 mm or less. In a case where the electric vehicle 200 is an SUV or a minivan with a high overall height, the electricity storage unit 100 preferably has a height of, for example, 150 mm or less.

In the electricity storage unit 100 arranged in the electric vehicle 200, the electricity storage devices 10 are configured not to be stacked on each other along the top-bottom direction, that is, the gravity direction. Thus, no weight of a stacked electricity storage device 10 acts on an electricity storage device 10 disposed below. In this way, it is possible to avoid damage to the outer package member 1 of an electricity storage unit 100 disposed below owing to a load resulting from the electricity storage devices 10 being stacked on each other. This allows the stable, long-term use of the electricity storage unit 100.

The electricity storage unit 100 according to the embodiment includes the cooling member 20 one at each of opposite sides of the electricity storage device aggregate 101 along the top-bottom direction, in other words, along the second direction Dz, which is orthogonal to the third direction Dx and to the first direction Dy. This is not meant as any limitation to such a configuration; so long as the electricity storage unit 100 can be adequately cooled, the cooling member 20 can be disposed only at one side.

The electricity storage unit 100 can be arranged in the electric vehicle 200 such that the third direction Dx (direction X) of the electricity storage devices 10 is aligned with the travelling direction. In this case, the electricity storage devices 10 are arranged such that the first direction Dy (direction Y) is aligned with the left-right direction of the electric vehicle 200. In this way, the second direction Dz (direction Z) of the electricity storage unit 100 is aligned with the height direction of the electric vehicle 200 (i.e., gravity direction). Accordingly, even when the electricity storage unit 100 is arranged on the electric vehicle 200, it has features as mentioned above.

### First Modified Example

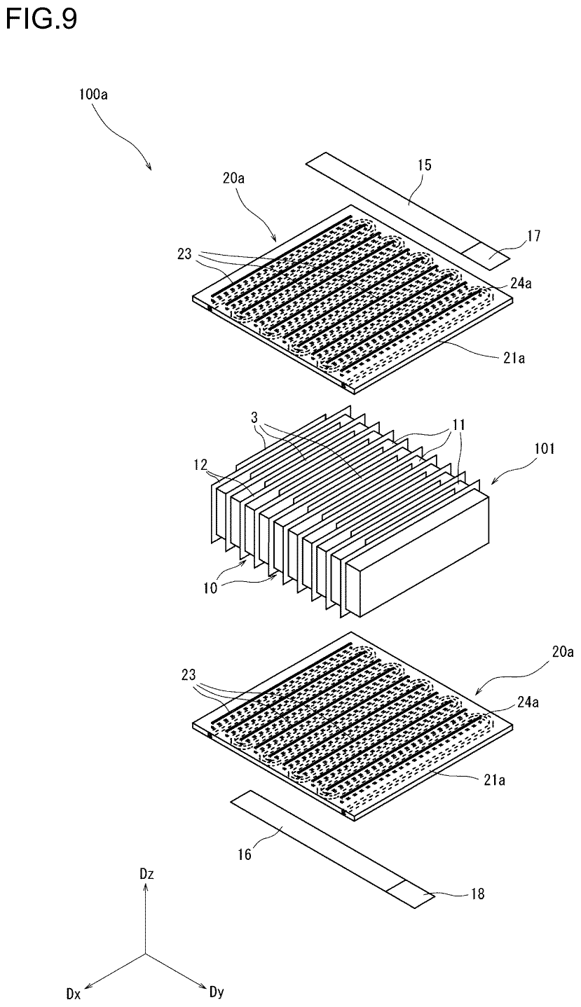

Now, other examples of electricity storage units will be described with reference to the relevant drawing. FIG. 9 is an exploded perspective view of an electricity storage unit 100a according to a first modified example. The electricity storage unit 100a shown in FIG. 9 has, in a cooling member 20a, a first cooling plate 21a that is different from the first cooling plate 21 in the cooling member 20 in the electricity storage unit 100. In addition, in the cooling member 20a, the second cooling plate 22 is omitted. In other respects, the structure of the electricity storage unit 100a is the same as that of the electricity storage unit 100. Thus, for such parts of the electricity storage unit 100a that are substantially the same as their counterparts in the electricity storage unit 100, the same reference signs are given and no detailed description will be repeated.

As shown in FIG. 9, the first cooling plate 21a in the cooling member 20a in the electricity storage unit 100a has a refrigerant passage 24a along with a slit 23. The refrigerant passage 24a has a configuration similar to that of the refrigerant passage 24 formed in the second cooling plate 22 in the cooling member 20. On the other hand, the refrigerant passage 24a has a configuration different from that of the refrigerant passage 24. Specifically, the refrigerant passage 24a is disposed in parts between adjacent slits 23. The refrigerant passage 24a connects around end parts of the slits 23 along the third direction Dx (direction X) from one part to the next between adjacent slits 23.

In this way, the refrigerant passage 24a is disposed over the entire region of the first cooling plate 21a in the cooling member 20a. Note that while, as shown in FIG. 9, the refrigerant passage 24a extends straight along the third direction Dx (direction X) in parts between adjacent slits 23, this is not meant as a limitation. For example, the refrigerant passage 24a can be formed so as to meander along the first direction Dy (direction Y). The longer the refrigerant passage 24a, the larger the area of contact between the refrigerant and the first cooling plate 21a, leading to higher cooling efficiency

### Second Modified Example

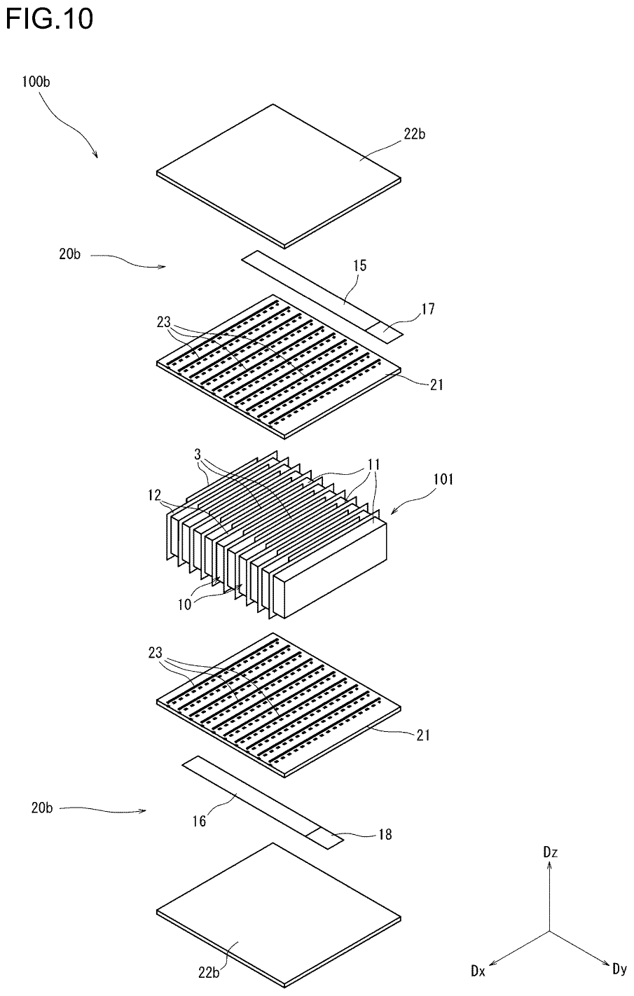

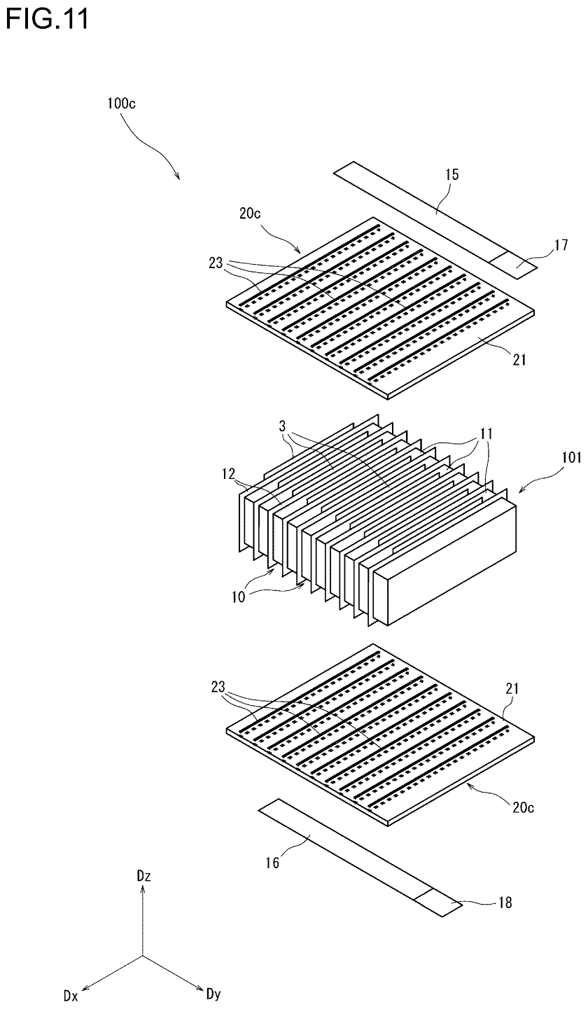

Another example of an electricity storage unit will be described with reference to the relevant drawing. FIG. 10 is an exploded perspective view of an electricity storage unit 100b according to a second modified example. The electricity storage unit 100b shown in FIG. 10 has, in a cooling member 20b, a second cooling plate 22b that is different from the second cooling plate 22 in the cooling member 20. In other respects, the structure of the electricity storage unit 100b is the same as that of the electricity storage unit 100. Thus, for such parts of the electricity storage unit 100b that are substantially the same as their counterparts in the electricity storage unit 100, the same reference signs are given and no detailed description will be repeated.

As shown in FIG. 10, the second cooling plate 22b in the cooling member 20b of the electricity storage unit 100b has no refrigerant passage. The heat generated in the electricity storage device aggregate 101 transmits via the first cooling plate 21 to the second cooling plate 22b. The second cooling plate 22b is disposed so as to cover each of the top and bottom surfaces of the electricity storage device aggregate 101. Thus, the second cooling plate 22b is in contact with the outside air over a large area, and can release much heat directly to the outside air. In a case where the electricity storage devices 10 can be adequately cooled by direct release of heat from the second cooling plate 22b, as in the second cooling plate 22b, there is no need for a refrigerant passage.

Eliminating a refrigerant passage helps simplify the configuration of the second cooling plate 22b and also eliminate components, such as a pipe, a pump, and a heat exchanger, that are connected to the refrigerant passage. It is thus possible to simplify a rechargeable battery system including the electricity storage unit 100b.

### Third Modified Example

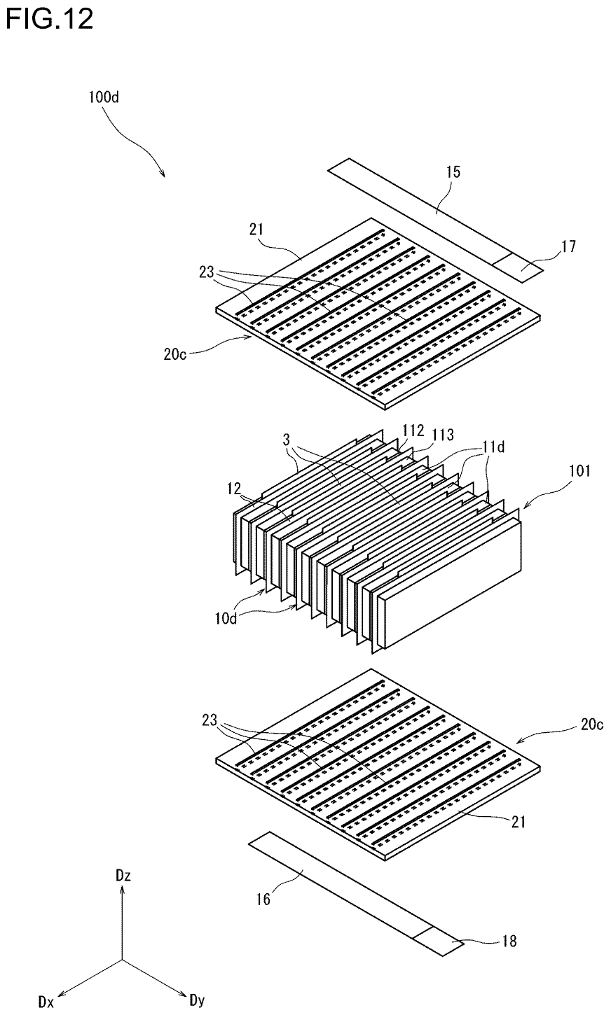

Yet another example of an electricity storage unit will be described with reference to the relevant drawing. FIG. 11 is an exploded perspective view of an electricity storage unit 100c according to a third modified example. The electricity storage unit 100c shown in FIG. 11 has a cooling member 20c that is different from the cooling member 20 in that it has no second cooling plate 22. In other respects, the structure of the electricity storage unit 100c is the same as that of the electricity storage unit 100. Thus, for such parts of the electricity storage unit 100c that are substantially the same as their counterparts in the electricity storage unit 100, the same reference signs are given and no detailed description will be repeated.

As shown in FIG. 11, the cooling member 20c in the electricity storage unit 100c includes only a first cooling plate 21. The heat generated in the electricity storage device aggregate 101 transmits to the first cooling plate 21. The first cooling plate 21 is disposed so as to cover each of the top and bottom surfaces of the electricity storage device aggregate 101. Thus, the first cooling plate 21 is in contact with the air flowing across the outer surface of the electricity storage unit 100c over a large area. In this way, the electricity storage device aggregate 101 can be cooled.

Eliminating a second cooling plate 22, which has a refrigerant passage, helps simplify the configuration of the electricity storage unit 100c and also eliminate components, such as a pipe, a pump, and a heat exchanger, that are connected to the refrigerant passage. It is thus possible to simplify a rechargeable battery system including the electricity storage unit 100c.

### Fourth Modified Example

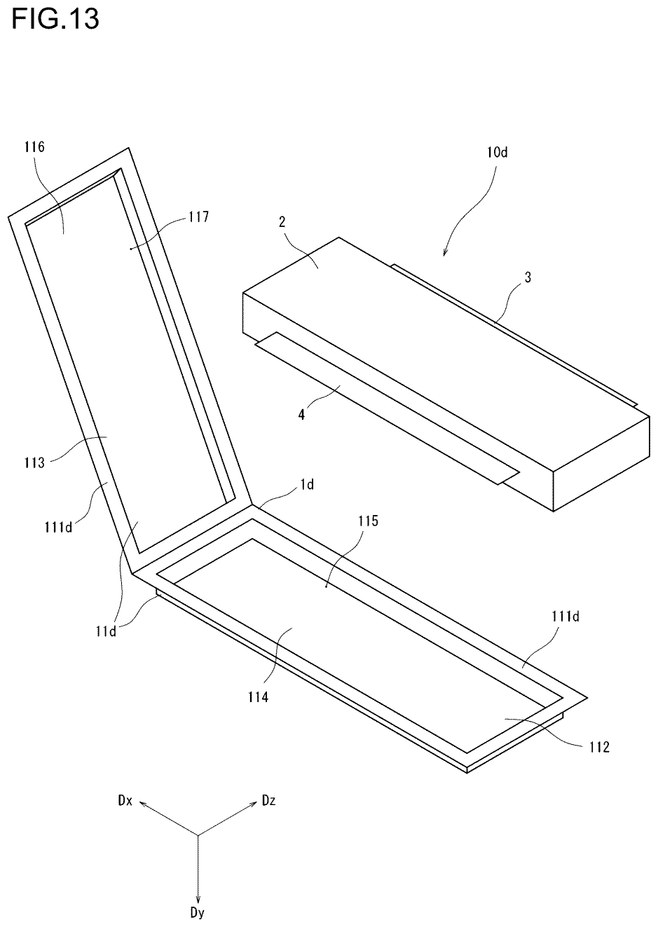

Still another example of the electricity storage unit 100 will be described with reference to the relevant drawings. FIG. 12 is an exploded perspective view of an electricity storage unit 100d according to a fourth modified example. FIG. 13 is an exploded perspective view of an electricity storage device 10d in the electricity storage unit 100d according to the fourth modified example. The electricity storage unit 100d has, in an outer package member 1d in the electricity storage device 10d, a housing portion 11d that has a configuration different from that of the housing portion 11 and the lid portion 13 of the outer package member 1 in the electricity storage device 10 in the electricity storage unit 100c shown in FIG. 11. In other respects, the structure of the electricity storage unit 100d is the same as that of the electricity storage unit 100c. Thus, for such parts of the electricity storage unit 100d that are substantially the same as their counterparts in the electricity storage unit 100c, the same reference signs are given and no detailed description will be repeated.

As shown in FIGS. 12 and 13, the housing portion 11d has a first and a second housing portion 112 and 113. The first housing portion 112 has a first box portion 114 and a peripheral sealing portion 111d. The first box portion 114 has, in one face of it, an opening portion 115 having substantially a rectangular shape and the peripheral sealing portion 111d extends outside an outer edge part of the opening portion 115.

As shown in FIG. 13, the second housing portion 113 has a second box portion 116 and a peripheral sealing portion 111d. The second box portion 116 has, in one face of it, an opening portion 117 having substantially a rectangular shape and the peripheral sealing portion 111d extends outside an outer edge part of the opening portion 117.

As shown in FIG. 13, the first and second housing portions 112 and 113 are formed unitarily with their peripheral sealing portions 111d coupled together along one shorter side.

The electricity storage device 10d is formed by combining together the first and second box portions 114 and 116 such that their respective opening portions 115 and 117 lie on top of each other and then thermally bonding together their peripheral sealing portions 111d.

In the so configured electricity storage device 10d, a flange portion 12 is disposed in a middle part of the housing portion 11d along the first direction Dy. Thus, when the flange portion 12 is inserted into a slit 23 in a first cooling plate 21 in a cooling member 20c, the flange portion 12, the electrode terminals 3 and 4, and the cooling member 20c can be fixed easily. In addition, heat transmits to the flange portion 12 and the electrode terminals 3 and 4 from opposite sides along the first direction Dy. This reduces temperature variation in the housing portion 11d and helps alleviate heat-induced deterioration.

### Fifth Modified Example

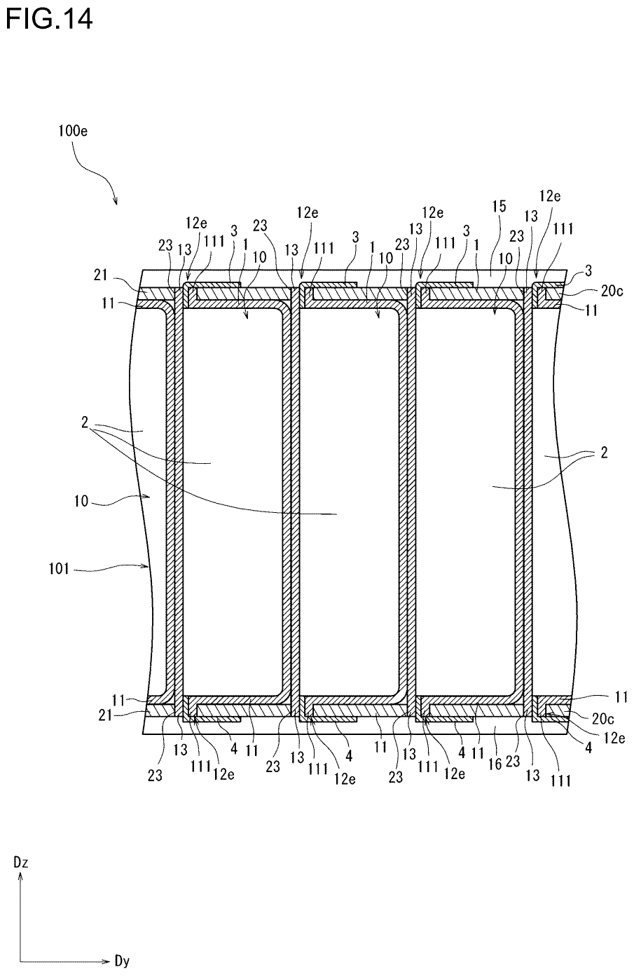

A further example of an electricity storage unit will be described with reference to the relevant drawing. FIG. 14 is a side sectional view of an electricity storage unit 100e according to a fifth modified example. The electricity storage unit 100e shown in FIG. 14 is different from the electricity storage unit 100c shown in FIG. 11 in that a peripheral sealing portion 111 is not fixed to a cooling member 20c. In other respects, the structure of the electricity storage unit 100e is the same as that of the electricity storage unit 100c. Thus, for such parts of the electricity storage unit 100e that are substantially the same as their counterparts in the electricity storage unit 100c, the same reference signs are given and no detailed description will be repeated.

As shown in FIG. 14, in the electricity storage unit 100e, a flange portion 12e does not protrude from the housing portion 11. Thus, only the electrode terminals 3 and 4 are bent to be fixed to a first cooling plate 21 in the cooling member 20c.

In the electricity storage unit 100e, a peripheral sealing portion 111 in the flange portion 12e is not fixed to the first cooling plate 21 in the cooling member 20c and only the electrode terminals 3 and 4 are fixed to the first cooling plate 21 in the cooling member 20c. In the electricity storage unit 100e, the heat generated in the electricity storage element 2 transmits via the parts of the housing portion 11 and the first cooling plate 21 where they are in contact with each other to the first cooling plate 21 as well as via the electrode terminals 3 and 4 to the first cooling plate 21. It is thus possible to suppress a rise in temperature in the electricity storage element 2. This allows stable, long-term operation of the electricity storage unit 100e.

Note that when the heat generated in the electricity storage element 2 can be adequately released to outside, only one of the electrode terminals 3 and 4 can be fixed to the first cooling plate 21 in the cooling member 20c.

### Sixth Modified Example

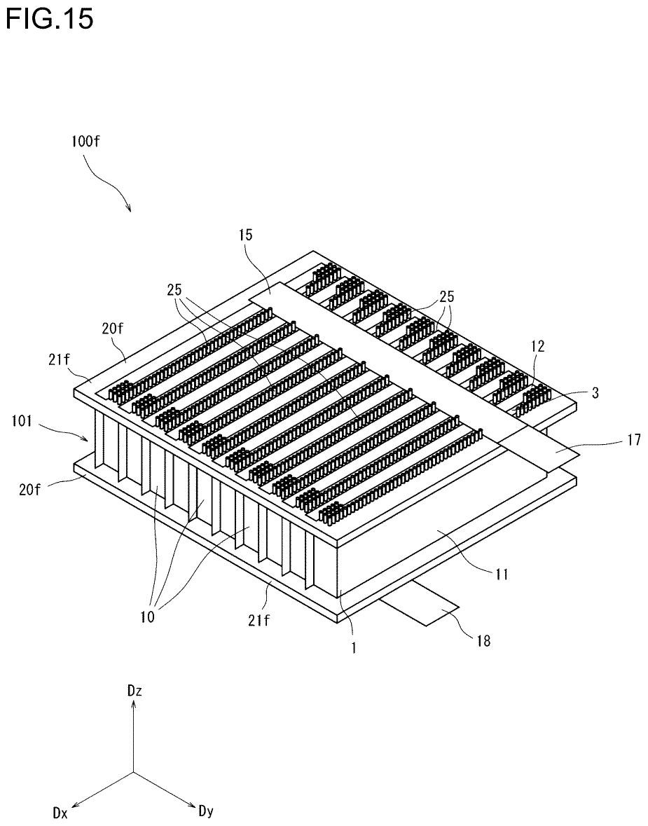

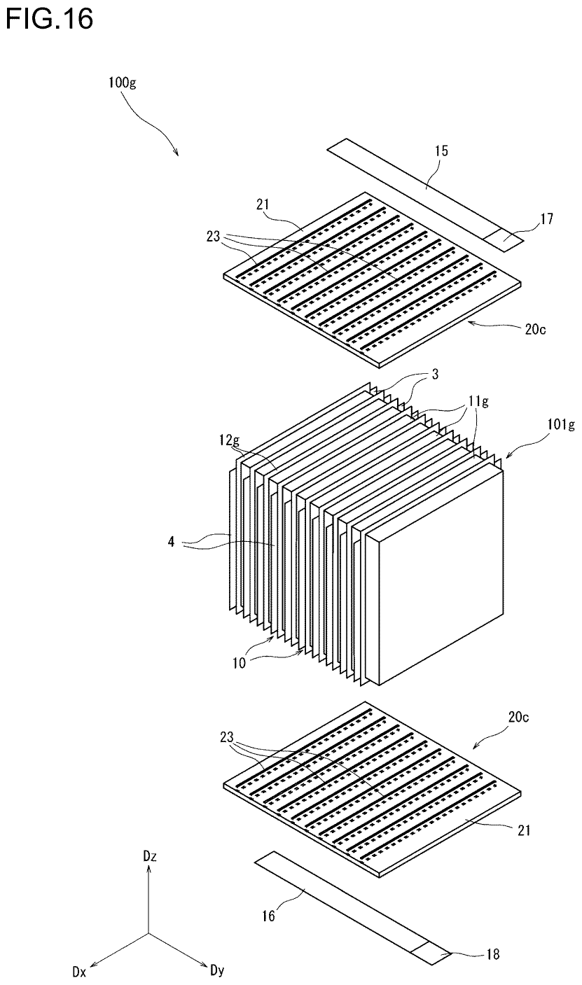

A still further example of an electricity storage unit will be described with reference to the relevant drawing. FIG. 15 is a perspective view of an electricity storage unit 100f according to a sixth modified example. In the electricity storage unit 100f shown in FIG. 15, a cooling member 20f is different from the cooling member 20c in the electricity storage unit 100c shown in FIG. 11. In other respects, the structure of the electricity unit 100f is the same as that of the electricity storage unit 100. Thus, for such parts of the electricity storage unit 100f that are substantially the same as their counterparts of the electricity storage unit 100c, the same reference signs are given and no detailed description will be repeated.

As shown in FIG. 15, the cooling member 20f in the electricity storage unit 100f has a first cooling plate 21f. The first cooling plate 21f has a plurality of protrusions 25 that protrudes from its surface. The protrusions 25 are formed unitarily with the cooling member 20f. As shown in FIG. 15, the protrusions 25 are in a cylindrical form. With the protrusions 25, the cooling member 20f has an increased surface area. That is, providing the protrusions 25 helps increase the amount of heat released to the outside, leading to accordingly higher cooling efficiency in the electricity storage unit 100f.

A fan (not shown) can be disposed outside the electricity storage unit 100f to blow a flow of air (forced air) across the protrusions 25 for forced cooling. This can lead to yet higher cooling efficiency in the electricity storage unit 100d. For example, in a case where the electricity storage unit 100f is used as a power source for the electric vehicle 200, arranging the electricity storage unit 100f such that the travelling wind blows across the protrusions 25 can lead to higher cooling efficiency in the electricity storage unit 100f.

Note that, while in the electricity storage unit 100f according to the modified example, the protrusions 25 on the first cooling plate 21f in the cooling member 20f are in a cylindrical form, this is not meant as any limitation. For example, they can instead be in a shape with a polygonal cross-section or they can be in a conic shape instead of a columnar shape. Or in a case where the forced air flows in a predetermined direction, they can be fins extending in the direction in which the forced air flows.

### Seventh Modified Example

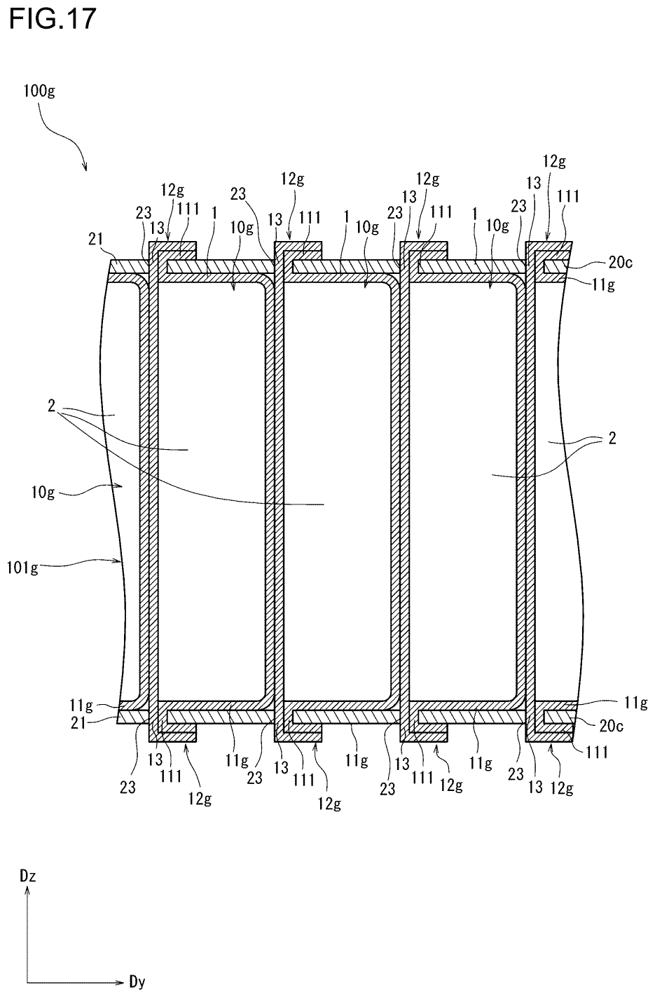

A yet further example of an electricity storage unit will be described with reference to the relevant drawings. FIG. 16 is an exploded perspective view of an electricity storage unit 100g according to a seventh modified example. FIG. 17 is a side sectional view of an electricity storage device 10g in the electricity storage unit 100g according to the seventh modified example. The electricity storage unit 100g is different from the electricity storage unit 100c shown in FIG. 11 in that a housing portion 11g in the electricity storage device 10g has a different shape. In other respects, the structure of the electricity storage unit 100g is the same as that of the electricity storage unit 100c. Thus, for such parts of the electricity storage unit 100g that are substantially the same as their counterparts in the electricity storage unit 100c, the same reference signs are given and no detailed description will be repeated.

In the electricity storage device 10g, the size and shape of an electricity storage element 2 are decided based on the desired discharge capacity. In a case where the desired discharge capacity is high, the electricity storage element 2 with a large volume is applied. To increase the discharge capacity, in the electricity storage device 10g, a housing portion 11g is formed substantially in a square shape as seen from the first direction Dy (see FIGS. 16 and 17).

In the electricity storage device 10g, the lengths of the housing portion 11g along the second direction Dz and along the third direction Dx are substantially the same. Thus, even if electrode terminals 3 and 4 protrude along the second direction Dz or along the third direction Dx, it does not greatly affect the efficiency of charging and discharging. Accordingly, in the electricity storage unit 100g according to the modified example, the electrode terminals 3 and 4 protrude from the opposite ends, respectively of an electricity storage device aggregate 101g along the third direction Dx. A first cooling plate 21 in a cooling member 20c is disposed at each end of the electricity storage device aggregate 101g along the second direction Dz and flange portions 12g of the electricity storage devices 10g disposed along the second direction Dz are disposed through slits 23. Only the flange portions 12g that are disposed through the slits 23 are fixed to the first cooling plate 21 in the cooling member 20c.

In this way, the housing portion 11g and the first cooling plate 21 in the cooling member 20c are in direct contact and thus the heat generated in the electricity storage device 10g easily transmits to the first cooling plate 21 in the cooling member 20c. The heat generated in the electricity storage device 10g transmits, also via the flange portion 12g, to the first cooling plate 21 in the cooling member 20c. That is, even in a case where, in the electricity storage unit 100g, the first cooling plate 21 in the cooling member 20c is arranged such that only the flange portions 12g are disposed through the slits 23, it is possible to suppress a rise in temperature in the electricity storage device 10g.

Accordingly, as in the electricity storage unit 100g, even in a case where the direction along which the electrode terminals 3 and 4 protrude is different from the direction along which the first cooling plate 21 in the cooling member 20c is arranged, inserting the flange portions 12g into the slits 23 in the first cooling plate 21 in the cooling member 20c and fixing the flange portions 12g to the first cooling plate 21 in the cooling member 20c can lead to higher cooling efficiency. This helps alleviate heat-induced deterioration of the electricity storage unit 100g.

While, in the electricity storage units according to the embodiments, the electricity device is a secondary battery, this is not meant as any limitation to secondary batteries; it can instead be a capacitor (electrolytic condenser, electric double layer capacitor, lithium-ion capacitor, or the like).

Also while an electric vehicle is dealt with as one example of a moving object that incorporates the electricity storage unit, the electricity storage unit can instead be incorporated in any other moving objects. For example, the electricity storage unit can be incorporated in a biped robot, a train, an airplane, a helicopter, a drone, an agricultural machine, a construction machine, or the like.

In addition, depending on the structure of a moving object, the electricity storage device can be installed in different manners and, for example, the electricity storage device can be arranged such that the depth direction of its housing portion (i.e., direction Y) is aligned with the height direction of the body of the moving object. In this case, a plurality of electricity storage devices are stacked on each other along the height direction of the body of the moving object and the electrode terminals extend along the horizontal direction. This can prevent the electrolyte filling inside the outer package member from lying toward one of the electrode terminals.

The electricity storage unit can be applied for any use other than in a driving source for a moving object. It can be used, for example, as a stationary power supply for an electric power storage system (energy storage system), a secondary battery electric power storage system (battery energy storage system), an uninterruptible power source device (uninterruptible power supply).

### Conclusion

According to the present invention, an electricity storage unit can be configured as follows.
(1) An electricity storage unit includes a plurality of electricity storage devices arrayed along a first direction and a cooling member in the form of a plate disposed close to the plurality of arrayed electricity storage devices along the second direction intersecting with the first direction. The electricity storage devices each include a housing portion that is in a rectangular form as seen from the first direction and that accommodates an electricity storage element and a flange portion that protrudes outward of the face of the housing portion intersecting with its face along the first direction. The cooling member has a plurality of slits through each of which at least part of a portion of the flange portion of one of the electricity storage devices protruding along the second direction is disposed. The flange portion disposed through the slits is fixed to the cooling member.
(2) An electricity storage unit includes a plurality of electricity storage devices arrayed along a first direction and a cooling member in the form of a plate disposed close to the plurality of arrayed electricity storage devices along the second direction intersecting with the first direction. The electricity storage devices each include a housing portion that is in a rectangular form as seen from the first direction and that accommodates an electricity storage element and an electrode terminal that is electrically connected to the electricity storage element and that protrudes from the housing portion along the second direction. The cooling member has a plurality of slits through each of which at least part of the electrode terminal of one of the electricity storage devices is disposed. The electrode terminal disposed through the slits is fixed to the cooling member.
(3) In the electricity storage unit according to (1), the electricity storage devices each include an electrode terminal that is electrically connected to the electricity storage element and that protrudes from the housing portion along the second direction. The electrode terminal is disposed through the slits together with the flange portion and is disposed in contact with the cooling member.
(4) In the electricity storage unit according to any one of (1) to (3), the cooling member has a refrigerant passage through which refrigerant circulates.
(5) In the electricity storage unit according to any one of (1) to (4), the cooling member has a plurality of protrusions protruding from its surface.
(6) In the electricity storage unit according to any one of (1) to (5), the cooling member is disposed at opposite sides of the plurality of arrayed electricity storage devices along the second direction.
(7) In the electricity storage unit according to (1) to (6), the cooling member includes a first cooling plate having the slits formed in it and a second cooling plate disposed at the side of the first cooling plate opposite from the electricity storage devices. At least part of a portion of the flange portion protruding from the slits is held between the first and second cooling plates along the second direction.

Note that the configurations specifically described above are not meant to limit the scope of the present invention, which thus allows for any modifications, and that any configurations obtained by combining together technical features disclosed in connection with different configurations fall within the technical scope of the present invention.

### INDUSTRIAL APPLICABILITY

The present invention finds application widely in any moving objects that install a dynamoelectric device.

### REFERENCE SIGNS LIST

1, 1d outer package member
2 electricity storage element
3,4 electrode terminal
10, 10d, 10g electricity storage device
11, 11d, 11g housing portion
12, 12e, 12g flange portion
13 lid portion
14 opening portion
15 cathode bus bar
16 anode bus bar
17, 18 lead-out terminal
20, 20a, 20b, 20c, 20f cooling member
21, 21a, 21f first cooling plate
22, 22b second cooling plate
23 slit
24, 24a refrigerant passage
25 protrusion
40 laminate sheet
41 base layer
42 barrier layer
43 thermal adhesive resin layer
100, 100a, 100b, 100c, 100d, 100e, 100f, 100g electricity storage unit
101, 101g electricity storage device aggregate
111, 111a, 111d peripheral sealing portion
112 first housing portion
113 second housing portion
114 first box portion
115 opening portion
116 second box portion
117 opening portion
200 electric vehicle
201 wheel
202 driving motor

1. An electricity storage unit comprising:
a plurality of electricity storage devices arrayed along a first direction; and
a cooling member in a form of a plate disposed close, along a second direction, to the plurality of electricity storage devices arrayed, the second direction intersecting with the first direction,
wherein
the electricity storage devices each include:
a housing portion in a rectangular form as seen from the first direction, the housing portion accommodating an electricity storage element; and
a flange portion protruding outward of a face of the housing portion intersecting with a face thereof along the first direction,
the cooling member has a plurality of slits through which at least parts of portions of the flange portions of the electricity storage devices protruding along the second direction are disposed, and
the flange portions disposed through the slits are fixed to the cooling member.

2. An electricity storage unit comprising:
a plurality of electricity storage devices arrayed along a first direction; and
a cooling member in a form of a plate disposed close, along a second direction, to the plurality of electricity storage devices arrayed, the second direction intersecting with the first direction,
wherein
the electricity storage devices each include:
a housing portion in a rectangular form as seen from the first direction, the housing portion accommodating an electricity storage element; and
an electrode terminal electrically connected to the electricity storage element, the electrode terminal protruding from the housing portion along the second direction,
the cooling member has a plurality of slits through which at least parts of the electrode terminals of the electricity storage devices are disposed, and
the electrode terminals disposed through the slits are fixed to the cooling member.

3. The electricity storage unit according to claim 1, wherein
the electricity storage devices each include an electrode terminal electrically connected to the electricity storage element, the electrode terminal protruding from the housing portion along the second direction, and
the electrode terminals are disposed through the slits together with the flange portions and the electrode terminals are disposed in contact with the cooling member.

4. The electricity storage unit according to claim 1, wherein the cooling member has a refrigerant passage through which refrigerant circulates.

5. The electricity storage unit according to claim 1, wherein the cooling member has a plurality of protrusions protruding from a surface thereof.

6. The electricity storage unit according to claim 1, wherein the cooling member is disposed at each of opposite sides, along the second direction, of the plurality of electricity storage devices arrayed.

7. The electricity storage unit according to claim 1, wherein
the cooling member includes:
a first cooling plate having the slits formed therein; and
a second cooling plate disposed at a side of the first cooling plate opposite from the electricity storage devices, and
at least parts of portions of the flange portions protruding from the slits are held between the first and second cooling plates along the second direction.

8. The electricity storage unit according to claim 2, wherein
the cooling member includes:
a first cooling plate having the slits formed therein; and
a second cooling plate disposed at a side of the first cooling plate opposite from the electricity storage devices, and
at least parts of portions of the electrode terminals protruding from the slits are held between the first and second cooling plates along the second direction.

9. The electricity storage unit according to claim 2, wherein the cooling member has a refrigerant passage through which refrigerant circulates.

10. The electricity storage unit according to claim 2, wherein the cooling member has a plurality of protrusions protruding from a surface thereof.

11. The electricity storage unit according to claim 2, wherein the cooling member is disposed at each of opposite sides, along the second direction, of the plurality of electricity storage devices arrayed.
